(19) United States
(12) Patent Application Publication
(10) Pub. No.: US 2022/0317463 A1
(43) Pub. Date: Oct. 6, 2022

(54) AUGMENTED REALITY HEAD-UP DISPLAY WITH STEERABLE EYEBOX

(71) Applicant: CY VISION INC., San Jose, CA (US)

(72) Inventors: Hakan UREY, Yenikoy, Istanbul (TR); Georgios Skolianos, Redwood City, CA (US); Erdem ULUSOY, Sariyer, Istanbul (TR); Goksen G. Yaralioglu, Los Altos, CA (US); Trevor Chan, San Jose, CA (US)

(73) Assignee: CY VISION INC., San Jose, CA (US)

(21) Appl. No.: 17/745,330

(22) Filed: May 16, 2022

Related U.S. Application Data
(63) Continuation of application No. PCT/TR2019/050955, filed on Nov. 15, 2019.

(51) Int. Cl. G02B 27/01; G02B 27/00

(52) U.S. Cl. CPC G02B 27/0179; G02B 27/0101; G02B 27/0103; G02B 27/0093; G02B 2027/0187; G02B 2027/0134

(57) ABSTRACT

A head-up display device/system includes a dynamically adjustable exit pupil plane. More specifically, the system and the teaching contained herein along with various embodiments relate to head-up display devices comprising at least one picture generation unit and optical steering apparatus which together form a means for displaying 2D and/or 3D virtual augmented images using the surfaces of objects such as windshields.

### PRIORITY

This application is a continuation of PCT/TR2019/050955, filed 15 Nov. 2019, which is entirely incorporated by reference.

### TECHNICAL FIELD

The disclosure generally relates to a head-up display system and device having a dynamically adjustable exit pupil plane. More specifically, present disclosure and the teaching contained herein along with various embodiments relate to head-up display systems and devices comprising at least one picture generation unit and optical steering apparatus which together form a means for displaying 2D and/or 3D virtual augmented images using the surfaces of objects such as windshields.

### BACKGROUND

Virtual head-up displays (HUD) are employed in aircraft, land vehicles, retail store windows to present a person/user with information overlaid onto immediate surroundings. Many vehicle HUDs make use of the inside surface of the windshield as an optical combiner to provide the user a 2D or 3D stereoscopic image of any relevant information to be delivered.

### SUMMARY

An important issue with traditional HUDs is that they lack abilities such as software-based aberration correction and eyebox adjustments. Aberration correction, in itself allows for a larger field-of-view (FOV) to be cast across a larger eyebox, albeit no single optical component can be designed to form a large FOV aberration-free image due to the fact that information radiating from the display is aberrated as it is reflected from the windshield of the vehicle. A dynamically adjustable eyebox HUD setup has many advantages over conventional HUD applications.

One of the prior art publications in the technical field may be referred to as WO 2016105285, which teaches a sharp foveal vision combined with low resolution peripheral display with a wide field-of-view (FOV) and a rotatable hologram module capable of creating a high-resolution steerable image. In another document, US US20180003981A1, a near-to-eye display device including an SLM, a rotatable reflective optical element and a pupil-tracking device are disclosed. The pupil-tracking device tracks the eye pupil position of the user and based on the data provided by said pupil-tracking device, the reflective optical element is rotated such that the light modulated by the spatial light modulator is directed towards the user's eye pupil.

DE 102011075884 discloses a head-up display device comprising a light-emitting image source along with optical elements that form a beam path. Optical elements comprise a holographic optical element with an optical imaging function and a reflector. Said reflector and the holographic optical element are arranged so that beams emitted by the former into a third section of the beam path can at least partly transilluminate the holographic optical element, wherein illumination angles of transilluminating beams in the third section of the beam path substantially deviate from angles of incidence at which part of the imaging function of the holographic optical element becomes effective.

GB 2554575 and EP 3146377 discloses a windscreen having spatially variant optical power likely to result in distortions, wherein the display has a shaped diffuser to compensate for the distortions of the windscreen and a holographic projector for projection of images thereon. The holographic projector has an SLM arranged to display a hologram representative of the image and apply a phase delay distribution to incident light, wherein the phase delay distribution is arranged to bring the image to a non-planar focus on the diffuser. The HUD may have a mirror with an optical power, or parabolic curvature, to redirect light from the diffuser onto the windscreen. In another aspect of application, a method of compensating for the spatially variant optical power of a windscreen is provided using the apparatus above wherein a virtual image is formed using the windscreen.

WO2018223646 discloses a dual-image projection apparatus includes a light source and a spatial light modulator including a first modulation module and a second modulation module. Additionally, the apparatus includes a Fourier lens and the spatial light modulator is positioned at a front focal plane of the Fourier lens. The first modulation module modulates light from the light source through the Fourier lens to reproduce a first 2D holographic image and the second modulation module modulates the light through the Fourier lens to reproduce a plurality of second 2D holographic images. The apparatus further includes a first light-diffusing film to display the first 2D holographic image to produce a first virtual image and a plurality of second light-diffusing films to respectively display the plurality of second 2D holographic images sequentially in a rate to produce a 3D virtual image.

US2017329143 discloses a heads up display system with a variable focal plane includes a projection device to generate light representative of at least one virtual graphic, an imaging matrix to project the light representative of the at least one virtual graphic on at least one image plane, a display device to display the at least one virtual graphic on the at least one image plane, and a translation device to dynamically change a position of the imaging matrix relative to the display device based, at least in part, on a predetermined operational parameter to dynamically vary a focal distance between the display device and the at least one image plane. Features of the head-up display system

One feature of the system is to provide a HUD with steerable exit pupils across an exit pupil plane and exit pupil volume.

Another feature of the system is to provide a HUD device wherein separate exit pupils are formed and independently steered for each eye, which is used for adjusting interpupillary distance, head tip, tilt, rotation; and head motion in three axes.

Another feature of the system is to provide a HUD that can deliver correct parallax and perspectives images to the eye by utilizing a pupil tracker and pupil follower system.

Another feature of the system is to provide a HUD device which include a pupil tracker to detect coordinates of viewer's pupils and their distance to the HUD.

A still further feature of the system is to provide a HUD device which includes a real-time rendering of correct perspective images to each eye.

Another feature of the system is to provide a HUD device consisting of at least one light module that is capable of providing virtual images focusable at different depths.

A further feature of the system is to provide a HUD device having at least one SLM, where corrections of aberration and interpupillary distance are calculated on at least one computing means and implemented on the SLMs to increase image quality and achieve large FOV.

A still further feature of the system is to provide a HUD device that utilizes beam steering simultaneously to deliver rays to both eyes of a user.

A still further feature of the system is to provide a HUD device which optical steering is utilized on two exit pupils separated by an adjustable interpupillary distance.

### BRIEF DESCRIPTION OF THE FIGURES

Accompanying drawings are given solely for the purpose of exemplifying an object reconstruction system, whose advantages over prior art were outlined above and will be explained in brief hereinafter.

The drawings are not meant to delimit the scope of protection as identified in the claims nor should they be referred to alone in an effort to interpret the scope identified in said claims without recourse to the technical disclosure in the description. The drawings are only exemplary in the sense that they do not necessarily reflect the actual dimensions and relative proportions of the respective components of any system or sub-system.

FIG. 1a demonstrates an example schematic view of a holographic HUD.

FIG. 1b demonstrates an example schematic view interface of the holographic HUD and to the vehicle computer and sensors.

FIG. 2a demonstrates an example PGU and projection system that forms a virtual image behind a windshield.

FIG. 2b demonstrates another example PGU and projection system that forms a virtual image behind a windshield.

FIG. 2c demonstrates another example PGU and projection system that forms a virtual image behind a windshield.

FIG. 2d demonstrates another example PGU and projection system that forms a virtual image behind a windshield.

FIG. 2e demonstrates another example PGU and projection system that forms a virtual image behind a windshield.

FIG. 3 demonstrates different setups with one or two picture generation unit and one or two exit pupils.

FIG. 4 demonstrates block diagrams of main components in the HUD system.

FIG. 5a demonstrates example steering in horizontal, vertical and axial directions.

FIG. 5b demonstrates an exemplary sequence for the initial calibration where stages are dynamically adjusted to match the eyeboxes to user's pupil.

FIG. 5c demonstrates an exemplary sequence for the initial calibration where stages are dynamically adjusted to match the eyeboxes to user's pupil with tracking spots.

FIG. 6a demonstrates tilted eyeboxes with different interpupillary distance (IPD).

FIG. 6b demonstrates tilted eyeboxes with different interpupillary distance (IPD) according to FIG. 6(a).

FIG. 7a demonstrates a first eyebox position generated through moving picture generation unit in a head volume cross section.

FIG. 7b demonstrates a second eyebox position generated through moving picture generation unit in a head volume cross section.

FIG. 7c demonstrates a third eyebox position generated through moving picture generation unit in a head volume cross section.

FIG. 8a demonstrates an example HUD opening with no-steering mirror.

FIG. 8b demonstrates an example HUD opening with flat steering mirror.

FIG. 8c demonstrates an example HUD opening with flat mirror.

FIG. 8d demonstrates an example HUD opening with curved mirror.

FIG. 9 demonstrates a HUD device having a movable illumination source.

FIG. 10 demonstrates a HUD system architecture using a spatial filter to eliminate undesired beams generated by SLMs.

FIG. 11 demonstrates movement of the eye box in response to tilting motion of a steering mirror.

FIG. 12a demonstrates an optical architecture where the steering mirror is placed at a plane between the imaging lens and the exit pupil plane, in top view.

FIG. 12b demonstrates an optical architecture where the steering mirror is placed at the location of the SLM image that forms between the imaging lens and the exit pupil plane, in side view.

FIG. 12c demonstrates an optical architecture where the steering mirror is placed between the SLMs and the imaging lens, in side view.

FIG. 13a demonstrates moving the exit pupil vertically for one eye to compensate for head tilt using an eye light module.

FIG. 13b demonstrates moving the exit pupil vertically for one eye to compensate for head tilt using mirrors.

FIG. 14a demonstrates HUD device with integrated steering mirror.

FIG. 14b demonstrates HUD device with an external steering mirror.

FIG. 14c demonstrates HUD device with an external tilted steering mirror.

FIG. 15 demonstrates HUD system architectures to achieve constant look down angles.

FIG. 16 demonstrates an alternative HUD system architecture using a holographic optical element on a windshield to achieve constant look down angle.

FIG. 17 demonstrates a smaller HUD structure provided by different fold mirror settings.

FIG. 18a demonstrates standard windshield and wedge windshield comparison with a first example eyebox size.

FIG. 18b demonstrates standard windshield and wedge windshield comparison with a second example eyebox size.

FIG. 18c demonstrates standard windshield and wedge windshield comparison with a third example eyebox size.

FIG. 18d demonstrates standard windshield and wedge windshield comparison with a fourth example eyebox size.

FIG. 19a demonstrates comparison of the change in angular separation between the virtual image and the ghost image among different wedge windshields and regular windshield with the change in virtual image distance.

FIG. 19b demonstrates the change in the angular separation between the virtual image and the ghost image as a function of the wedge angle.

FIG. 19c demonstrates the change in the distance between the center of the exit pupil and the ghost eyebox is shown as a function of the wedge angle.

FIG. 20 demonstrates an example of a dashboard image layout to be displayed on the HUD.

FIG. 21 demonstrates a top perspective view of a steering mirror.

FIG. 22 demonstrates use of peripheral display surrounding the central display.

### DETAILED DESCRIPTION

The following numerals are referred to herein:
10) Head-up display system or device (HUD)
101) Windshield
101a) Standard windshield
101b) Wedge windshield
102) Head-tracker camera
103) Vehicle computer
104) Head-tracking control
105) Virtual image
106) Picture generation unit (PGU)
11) Light source
111) Illumination lens
12) Light module
13) Spatial light modulator (SLM)
14) Desired modulated beam
14b) Undesired beams
151) Spatial filter
16) Exit pupil
16a) Exit pupil for left eye
16b) Exit pupil for right eye
17) Exit pupil plane
18) Optical steering apparatus
20) Processing circuitry
21) User's eye
21b) User's pupil
22) Imaging lens
23) Steering mirror
23a) Flat steering mirror
23b) Curved steering mirror
24) Intermediate exit pupil plane
27) Tracking spot
29) Peripheral display
30) Central display
31) Foveated display
32) Intermediate image plane
33) Beam splitter
201) Small IPD, no head-tilt
202) Large IPD, no head-tilt
203) Small IPD, tilted head
204) Virtual image plane
205) Ghost exit pupil
206) Holographic optical element (HOE)
207) HUD opening
208) Ghost image
209) Motion degrees of freedom
210) Look down angle
211) Fold mirror
212) Head volume
213 Virtual steering mirror location

A device and a system in the form of an augmented reality head up display device (10) with adjustable eyebox and a system comprising thereof is disclosed. Herein, eyebox is a term which can be used interchangeably with exit pupil (16). More specifically, a device and a system comprising at least one picture generation unit (106) and optical steering apparatus (18) which together form a means for displaying 2D and/or 3D virtual augmented images using the surfaces of objects such as windshields (101).

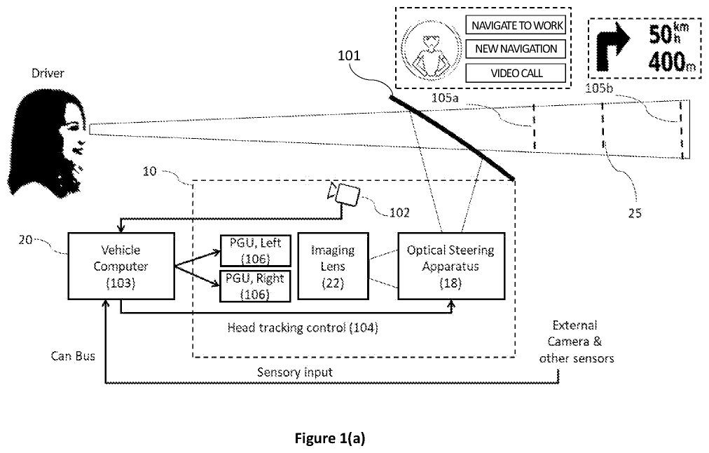

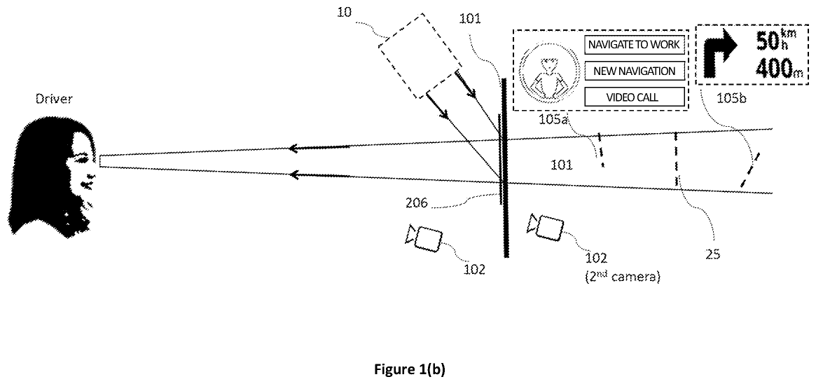

Referring to FIG. 1a and b, HUD (10) comprises of optical steering apparatus (18) aimed to create a steerable eyebox in front of the driver's eyes, a head tracker camera (102) or multiple cameras for tracking the driver's head motion, face, and user's pupils (21b), and a head tracking control (104) system. Other input from external sensors and vehicle's sensors as well as the input from the head-tracking control (104) are analyzed at the vehicle computer (103) and the proper content is calculated to be shown at the HUD (10) system. The driver sees the virtual image (105) at the distance determined by the HUD (10).

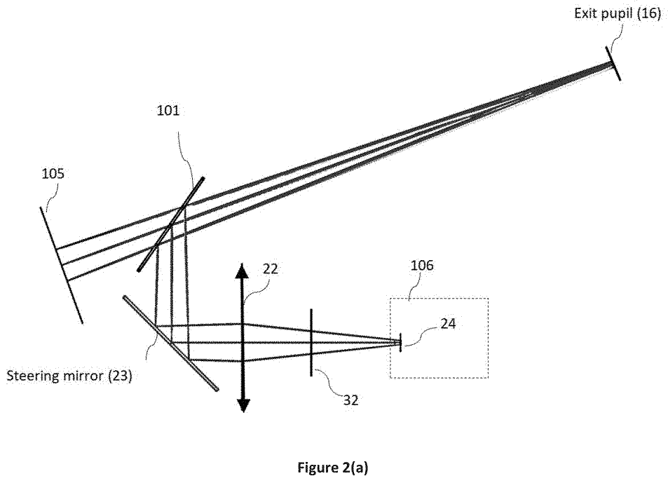

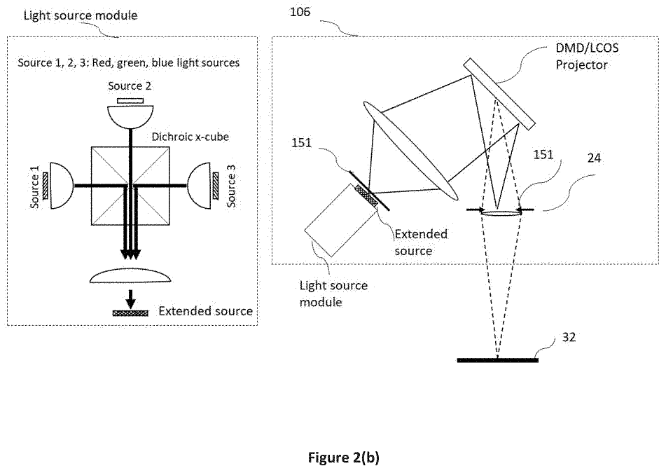

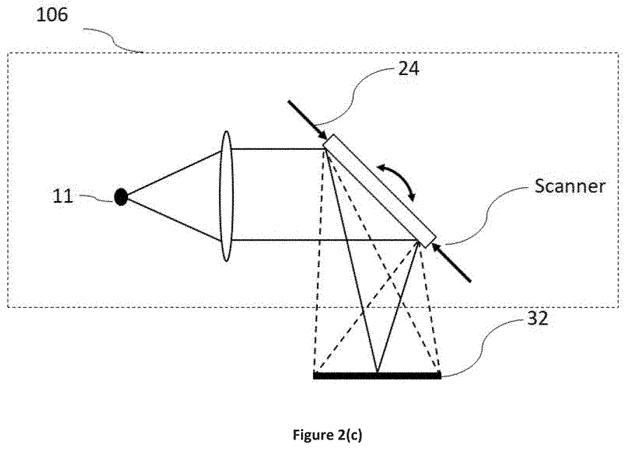

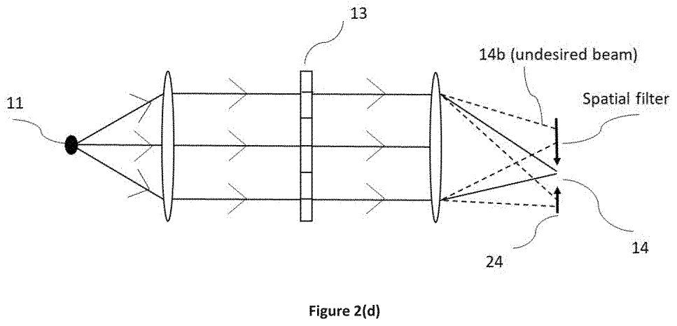

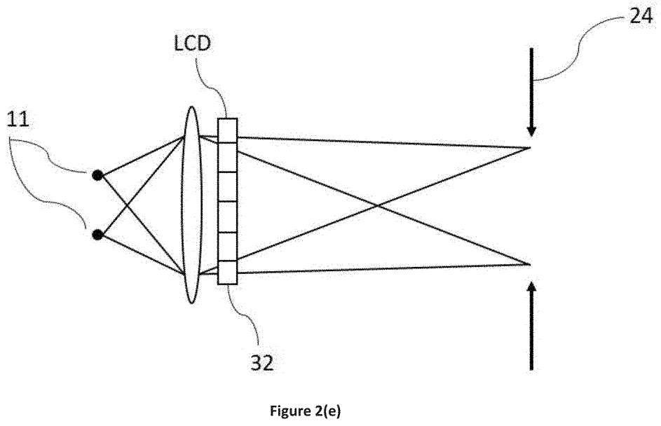

Referring to FIG. 2a, the HUD (10) device optics form exit pupil(s) (16) at the exit pupil plane (17). PGU (106) consists of at least one from each of the following components: microdisplay or SLM (13), light source (11), illumination lens (111) for beam shaping and fold mirrors (211). The figure shows a cross-sectional view. One PGU (106) may be sufficient for each eye of the user. In this embodiment, steering mirror (23) is after the imaging lens (22), which results in smaller footprint for the beam on the steering mirror (23), since the instantaneous eyebox or exit pupil (16) size can be made smaller. The field-of-view (FOV) of the system can be measured from the exit pupil plane (17) to the footprint on the windshield (101). For a fixed field-of-view (FOV), rotation of the steering mirror (23) moves the exit pupil (16) location without increasing the size of the optical beam on the imaging lens (22). The PGU (106) is followed by imaging lens (22) and windshield (101). The overall system is designed such that the intermediate image plane is optically conjugate to the virtual image plane and viewer's retina, and the intermediate exit pupil plane is optically conjugate to the actual exit pupil plane, where the user's eye pupils are present. Depending on the optical design, lenses of the PGU may be placed before, on or after the intermediate exit pupil plane.

Referring to FIG. 2b, an RGB-based additive color/light model is shown on the left-hand side as a light source module according to at least one embodiment. A dichroic prism in the form of an x-cube is utilized in a spatially centered fashion between three different light sources emitting red, green and blue light through short focal length collimator lenses respectively in clockwise direction. Combined light beam exits the dichroic x-cube towards the extended source. Light sources can be LED or laser based light sources or a combination. The size of the source is adjusted to limit the spatial coherence of the light source. In the right-hand side FIG. 2b, light source module of the left-hand side is shown along with the extended source behind a spatial filter (151). In such embodiments, the PGU is implemented using a DMD or an LCOS as the image source. Light generated by the light source module is imaged on the intermediate exit pupil plane (24), and the DMD or LCOS device is placed on the converging beam path, possibly in a tilted fashion as illustrated. A spatial filter (151) may be placed on the intermediate exit pupil plane (24) whereafter a lens or combination of lenses in the PGU (106) exists before an intermediate image plane (32) according to at least one embodiment.

Referring to FIG. 2c, a light source (11) and lens configuration and a scanner coinciding with an intermediate exit pupil plane (24) such that the PGU (106) is implemented using a scanning laser projector. Scanner can be a two 1D scanners or one 2D scanner fabricated using MEMS technology. In this embodiment, the exit aperture of the scanning laser projector becomes the intermediate exit pupil plane (24) of the system, which is imaged on the exit pupil (16) formed on the exit pupil plane (17). Said scanning laser projector creates an intermediate image at the intermediate image plane (32) each pixel thereof is created by a certain angle of the scanner according to at least one embodiment.

Referring to FIG. 2d, a holographic projector comprising a light source (11) and lens configuration as well as an SLM (13) placed on a nearly collimated beam path creating an intermediate exit pupil on the intermediate exit pupil plane (24) via the computer-generated holograms displayed thereon. The intermediate exit pupil plane (24) is populated with undesired beams (14b) as well, such as higher order replicas of exit pupil and unmodulated beams, etc. A spatial filter (151) placed on the intermediate exit pupil plane (24) eliminates the undesired beams (14b) and only lets the signal beam or the desired modulated beam (14) go through.

Referring to FIG. 2e, an LCD panel with two back illumination light sources is shown according to at least one embodiment. In such an embodiment, the PGU (106) is implemented using a single transmissive LCD panel as the image source. Light generated by the light source module is imaged on the intermediate exit pupil plane (24), and the LCD is placed on the converging beam path. A spatial filter (151) may be placed on the intermediate exit pupil plane (24) to control the size of the system exit pupil (16). For a more generic display implementation, the entire display system can function without requiring additional imaging lens (22) wherein the user's eyes (21) can be placed directly at the intermediate exit pupil plane (24).

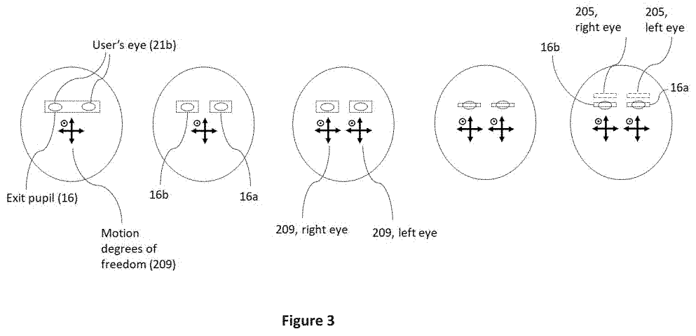

Conventional (non-tracked and non-steered HUDs) have an exit pupil of about 13 cm by 13 cm to cover driver interpupillary distance variations, driver height variations and vertical, horizontal and axial movements and tilt of user's head when the HUD is in use. In prior art, an optical diffuser or a numerical aperture expander is used for enlarging the exit pupils (16). Said optical diffuser or numerical aperture expander provides only unidirectional passage of light rays, therefore it will be harder to direct and manipulate the rays as desired. Moreover, the system aims to achieve smaller exit pupil (16), therefore intermediate image plane is free of any optical diffuser or numerical aperture expander. FIG. 3 shows another embodiment, wherein a smaller exit pupil (16) is formed and steered on the exit pupil plane (17) along with the eye positions of the driver. In this way, the required volume of the optical system becomes much smaller for a given FOV, since the set of rays the HUD (10) should provide at an instant gets significantly reduced. Further, windshield (101) related ghost images caused by the reflection from the back side (outside facing side) of the windshield (101) may be totally avoided, even in the case of standard windshields (101a) (wedge windshields are not required). This is due to the fact that with smaller exit pupils (16), ghost exit pupils (205) and actual exit pupils (16) get clearly separated. Also, whereas wedge solutions in conventional HUDs help avoiding ghost effects merely within the vicinity (an interval of about 0.1 diopters) of the virtual image distance, eye tracked HUD configurations avoid ghosts for all virtual image distances. Eye tracked HUD systems can perform dynamic distortion correction, which in principle can provide zero image distortion at all possible viewpoints of the driver. In contrast, non-eye tracked conventional solutions can provide distortion free images only at a subset (mostly consisting of one or two points) of the large exit pupil (16), and special care needs to be taken to ensure that distortion stays within tolerances in the remaining portions of the exit pupil (16), usually complicating the optical design thus increasing the HUD volume. Eye tracked HUDs, providing a larger portion of the generated light into driver's eyes, and wasting less of it on the driver's face, are obviously much more light efficient.

The first image on the FIG. 3 shows an embodiment with one exit pupil (16) and one picture generation unit (PGU) (106). Realization-wise, this case is the easiest option. There is only one exit pupil (16) and one PGU (106). It is just enough to cover both user's pupils (21b), with a typical size of 7-8 cm in horizontal and 0.3-1 cm in vertical. For a standard windshield (101), when the short edge of said exit pupil (16) is smaller than 1 cm, exit pupil (16) and ghost exit pupil (205) do not substantially overlap. If the said length is smaller than 5 mm, even further performance is achieved. As the driver moves his/her head in a pre-defined head volume (212), the eyebox can be steered in horizontal, vertical and axial directions to best match the user's pupil (21b) positions. The head-volume is greater than 10 cm×10 cm in the transverse plane and the distance from windshield can vary from 80 cm to 120 cm in a typical car in axial and longitudinal direction, respectively. This approach, while being more light efficient compared to conventional non-eye-tracked HUDs, still suffers from some light inefficiency since the light between the two eyes gets lost. Dynamic distortion correction is possible, but limited since a common display addresses both eyes. Steering of the eyebox is provided by actuators providing three motion degrees of freedom (209) (horizontal, vertical, and axial motion).

The second image on the FIG. 3 shows an embodiment with two exit pupils (16) and one PGU (106). This option is more light efficient version of one exit pupil (16) and one PGU (106) solution, where light is only provided to the user's pupils (21b)—no light is wasted at the facial region between the user's pupils (21b). This may be realized by using two separate illumination modules within the PGU (106), one for each eye. Illumination modules comprise red, green, and blue light sources such as LEDs or lasers. It can further comprise collimation and focusing lenses, and color beam combiners such as dichroic mirrors, pellicle beam splitters, holographic combiners, or x-cubr combiners. Each eyebox is about 0.5-1 cm in vertical, and 1-2 cm in horizontal.

The third image on the FIG. 3 shows an embodiment with two exit pupils (16) and two PGUs (106). Two distinct PGUs (106) provide two separate eyeboxes to each eye. Due to having two independent PGUs (106), in principle the system is able to deliver distortion free images to both eyes for every possible position of the user's pupils (21b). The system can steer the exit pupil for left eye (16a) and exit pupil for right eye (16b) independently using the actuators to control the three motion degrees of freedom (209).

An intermediate option between embodiment with two exit pupils (16) and one PGU (106) and embodiment with two exit pupils (16) and two PGUs (106) is to have common actuators for left and right eye boxes to steer the exit pupil for left eye (16a) and exit pupil for right eye (16b) together using the three motion degrees of freedom (209). Though being easier implementation-wise, this solution is limited in the range of eye positions that can be addressed.

Instantaneous exit pupils (16) are defined on the extended exit pupil region which is a cross section of the head volume (212). The exit pupils (16) move as dynamic targets on an extended exit pupil region.

In the illustrated option, separate actuators are used for each eyebox, providing the ability to control a wide set of possible eye positions, including head tilts, IPDs, movements, etc. Each eyebox is about 0.5-1 cm in vertical, and 1-2 cm in horizontal.

The fourth and fifth images on the FIG. 3 are similar to what shown is on the third image, except for the fact that the eyebox are made deliberately narrower in the vertical (down to about 3 mm). This way, windshield (101) related ghosts exit pupils (205) can be eliminated as well, by using user's pupils (21b) as filters. Ghost exit pupil(s) (205, left eye and 205, right eye) appear above or below the exit pupil for left eye (16a) and exit pupil for right eye (16b) with the intermediate distance being determined by the thickness and wedge angle of the windshield, and the distance to the driver.

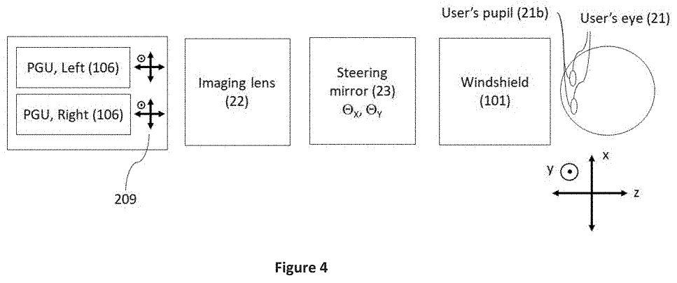

FIG. 4 shows the generic architecture of a HUD system with steerable exit pupils. Two PGUs (106) one for each eye, consist of light sources and sources of visual information (such as liquid crystal display (LCD), liquid crystal technology on silicone (LCoS) microdisplays, spatial light modulators, micro organic light-emitting diode (OLED) displays, scanning pico-projectors, digital mirromirror devices (DMDs), etc.). The PGUs (106) form a first replica of exit pupils (16), which are named the intermediate exit pupils. The intermediate exit pupils are imaged by the combination of imaging lens (22), steering mirror (23) and windshield (101) to form the actual exit pupils on the exit pupil plane (17), where the user's eyes (21) are present. The user's eyes (21) can move in any combination of horizontal, vertical or axial directions. The actuators within the system are used to steer the exit pupils along with the user's pupils (21b). In the illustrated embodiment, an actuation scheme with a total of 8 degrees of freedom (209) actuation is used. Two separate x/y/z stages are attached to each PGU (106), supplemented by a steering mirror (23) which tilts the beams from both PGUs simultaneously in horizontal and vertical directions.

If the user's head were restricted to move merely on the transverse (x-y) plane but not in the axial (z) direction, and if it was guaranteed that user's head will not have any significant tilt (i.e. no significant difference in the vertical position of left and right eyes), the steering mirror (23) itself would be sufficient. To account for axial motion of user's head, the z stages on the PGUs (106) may be used. In an embodiment, if the user moves away from the windshield (101), the PGUs (106) can be brought closer to the imaging lens (22), so that the actual exit pupils form further away from the windshield (101), and vice versa. It should be noted, however, that, changes in the axial position of an image are in general accompanied by changes in lateral magnification as well, leading to change in the distance between left and right exit pupils. The x stages in the PGUs (106) may be used to keep the magnification and hence the IPD constant. As an example, when PGUs are brought closer to the imaging lens, the horizontal distance between them can be reduced, so that the distance between actual exit pupils is kept the same on the user side. The y stages on the PGUs are mainly needed to account for vertical differences in the position of the eyes of a user, caused by tilted head poses or non-planar positioning of the user's pupils (21b) in the vertical axis. The imaging lens (22), or lens system can also have an adjustable focal length in order to adjust the z position of the exit pupil (16).

Although the main responsibility of each actuator is as stated above, it should be noted that in a real optical design, whereby system aberrations and other deviations from paraxial behaviour are taken into account, such simple associations between user motion and actuator parameters may not be perfectly possible. In general, the actuator parameters are to be simultaneously optimized so that the exit pupils are matched to a given pair of left and right eye and pupil locations to the best possible extent.

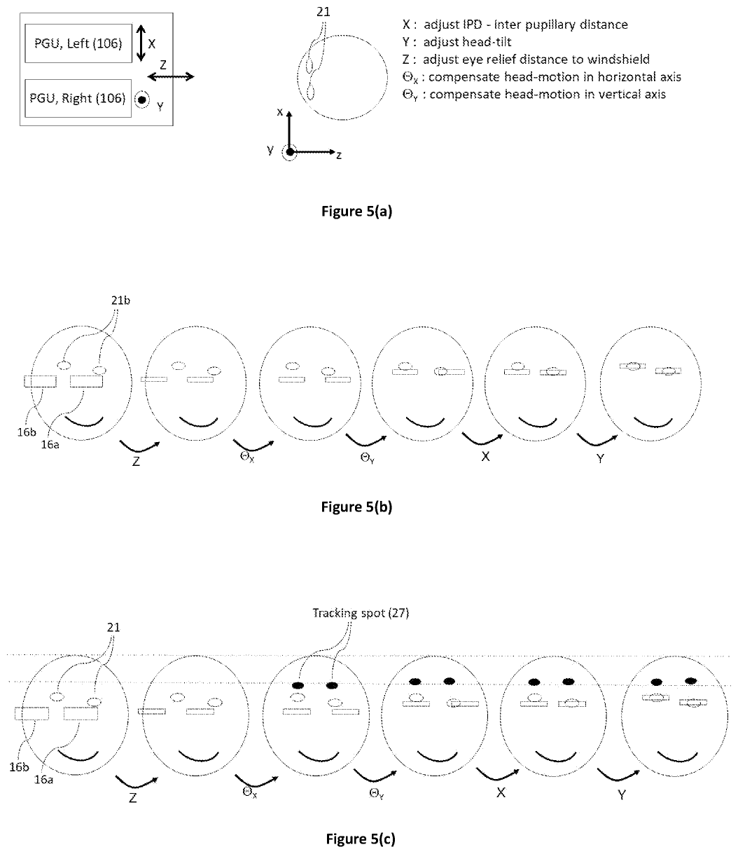

FIGS. 5a and 5b shows different implementations that may be used to drive the actuators. In one embodiment; X, Y and Z stages (3 axes) may be adjusted at the beginning when a driver sits in the driver seat. Then, they are not modified unless the driver makes a significant change in his/her position. Such initial calibration can be repeated intermittently during use. The □x, □y stages are dynamically adjusted to match the eyeboxes to user's pupil (21b) at every time instant. In another embodiment, all stages are dynamically actuated so that the exit pupils (16) get imaged on the pupils of the driver in an optimum manner, at every time instant. Note that although each actuator is mainly responsible for one type of user parameter or motion (as listed), particular details of the HUD optics may introduce some minor coupling between effects of actuators. Because of this, a fully optimized tracking in general would require all actuators to be adjusted dynamically and real-time.

FIG. 5c shows an exemplary sequence similar to that in FIG. 5b where two tracking spots (27) are formed on the face on the driver. The tracking spots (27) provide a closed loop feedback mechanism for the head-tracking control (104) system to ensure that the actuators are indeed adjusted to match the exit pupils (16) to the eyes of the user. The spots can be formed by infrared lasers hitting the face of the user, and may be identified with an infrared head-tracker camera (102) directed towards the face of a user.

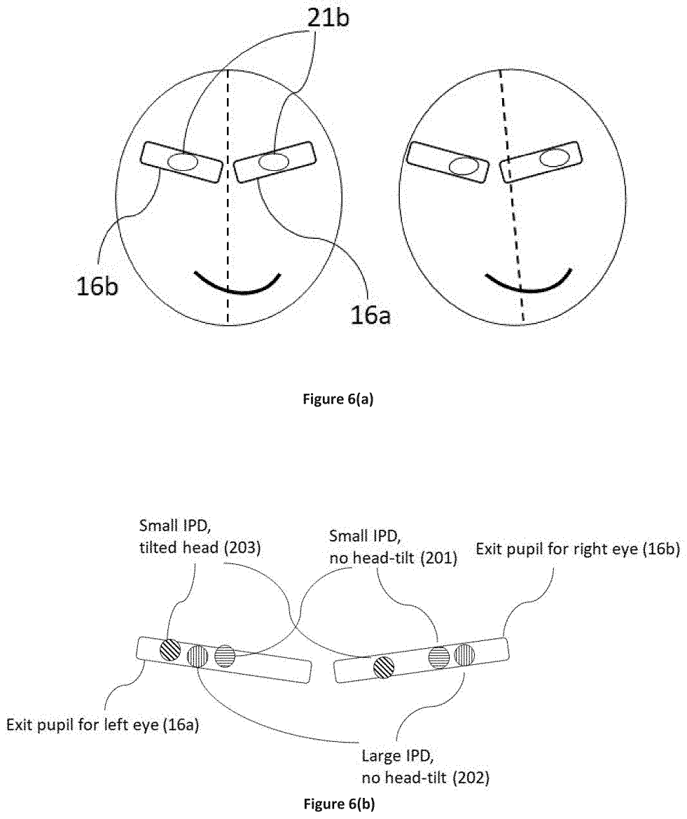

FIG. 6 shows an embodiment where the exit pupils (16) are formed such that they have a wide horizontal size and are tilted. In this way, various IPD sizes as well as head tilts can be addressed with the optical steering apparatus (18), but no further X or Y motion of the PGUs (only z motion). With no head tilt present, the eyes of the driver with small IPD, no head-tilt (201) are placed at the inner and bottom corners of the exit pupils (16), while the eyes of the large IPD, no head-tilt (202) driver are placed at the outer and top corners of the exit pupil (16). When there are head tilts, different portions of the exit pupil can be matched to the eye pupils, as an example, driver with small IPD, tilted-head (203) exit pupil placement with respect to the user's pupil (21b) case is illustrated in the figure. Such a tilted exit pupil (16) can be formed by: adjusting the illumination area of the light source for the DMD and LCOS projector illustrated in FIG. 2b; or by tilting the SLM (13) in the case of holographic projector based PGU (106) illustrated in FIG. 2d; or by using an exit pupil expander such as tilted lenticular lens array or tilted 1D diffuser at the intermediate image plane (32) for the scanning laser projector illustrated in FIG. 2c.

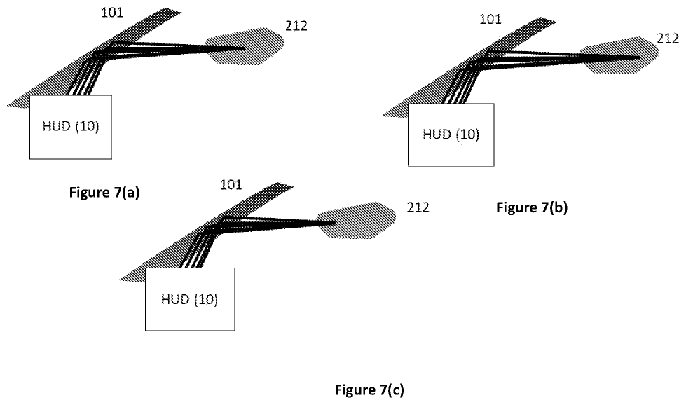

FIGS. 7a, 7b and 7c show three alternative axial positions of the head of a driver within the allowed head volume (212) for the user, and how the actuators within the HUD (10) are configured to move the exit pupils (16) back and forth in the axial direction so as to match them to the eye pupils of the driver.

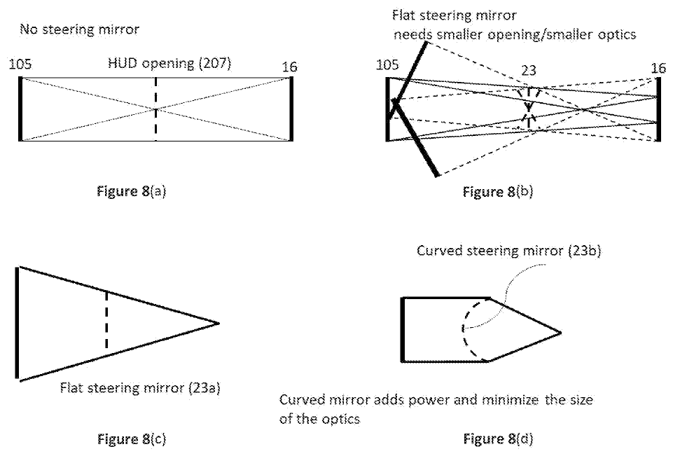

FIG. 8a shows a conventional HUD with a large exit pupil (16) (delivered at all times), requires a large HUD opening (207). FIG. 8b shows an eye tracked HUD (10) delivers a small exit pupil (16), which is steered with a steering mirror (23) placed at the HUD opening (207). This way, the required size of the HUD opening (207) is reduced, as well as the required volume of the HUD lying beneath the steering mirror (23). Flat steering mirror (23a) is effective in moving the eyebox and reducing the required HUD volume. Imaging lens (22) dimensions and the required volume of the HUD can be further reduced by using a curved steering mirror (23b). Formula of size of HUD opening:
wH=wE+dH/dV*(wV−wE)
wV: size of virtual image
dV: distance of virtual image to exit pupil plane
wE : size of eyebox
dH: distance of HUD opening to exit pupil plane
wH: size of HUD opening
Note: Display FOV is given by
FOV=2*atan(wV/(2*dV))

Referring to FIG. 8c, a flat mirror (23a) used as the optical steering apparatus (18) according to an embodiment is shown. Usage of a flat steering mirror (23a) does not affect the degree of divergence of convergence of light.

Referring to FIG. 8d, a curved steering mirror (23b) used as the optical steering apparatus (18) according to an embodiment is shown. Usage of a curved steering mirror (23b) makes an incoming beam more convergent, providing the opportunity for the optical system preceding the mirror to be more compact.

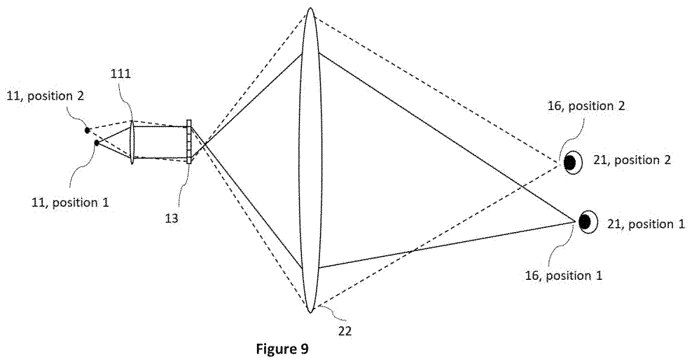

Referring FIG. 9, the system provides a HUD (10) having a movable illumination source, which can relate to a movable pupil position.

Moreover, the system provides a HUD (10) having an addressable array of illumination sources, which can relate to a movable pupil position.

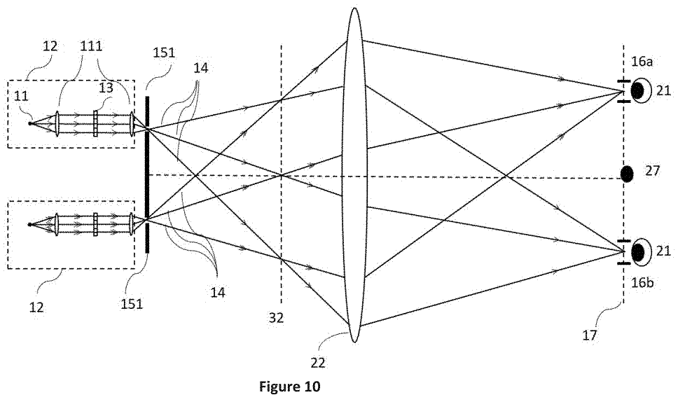

FIG. 10 shows a general schematic view of a HUD (10) comprising a light source (11), two light modules (12), which is similar to PGUs (106) but referred to as the light module (12) for the holographic projector, imaging lens(es) (22) and a spatial filter (151). Light source (11) consist of red, green, and blue LEDs or laser light sources. is followed by the illumination lenses (111), which can be located before or after the SLM (13) and deliver rays to the spatial filter (151) plane.

Referring to FIG. 10, holographic HUD basic optical system architecture uses a spatial filter (151) to block the undesired beams (14b), particularly for holographic projection based systems. Undesired beams (14b) are typically generated by the SLM (13) and the spatial filter (151) let the desired modulated beams (14) (the beams that would provide the visual information to the viewer within the exit pupils (16)) reach the exit pupil plane (17). Two light modules (12)—one per eye—are utilized to form an initial copy of the exit pupils (16). The visual information is generated by the PGUs (106). Computer generated holograms are displayed on the SLM as phase-only patterns computed using special algorithms and can show virtual images (105) at different depths.

In order to achieve a light-efficient and small exit pupil HUD (10) system, each light module (12) images the at least one point light source (11) onto the spatial filter (151) plane. In another embodiment the HUD may have a single light module for both eyes with two point light sources (one for each eye). The undesired beams (14b)—the unmodulated beam, noise beam, and higher order replicas—get spatially separated in the spatial filter (151) plane, and hence can be filtered out with apertures that let only the desired beam to pass unaffected. In FIG. 10, the optics module is implemented as a simple 4-f telescope. In an actual design, it should be noted that this module can be any imaging system that images the source to the spatial filter plane (151), and may include reflective, refractive, multi-part, conventional, diffractive, freeform components, some of which may be used off-axis and/or to introduce folds. Likewise, SLM (13) is illustrated as a transmissive component, but it can be reflective component. In a different embodiment, off- axis illumination directly from the light source (11) or a waveguide plate can be used to illuminate the SLM (13). Waveguide plate can be used to couple light in and out of the waveguide, which guide the light using total internal reflection.

The spatial filter (151) plane, consisting of the apertures that only pass the signal beams for left and right eye, gets imaged to the actual exit pupil plane (17) where the eyes of the viewer would be present. That imaging is performed in the figure by the imaging lens (22). The imaging may in general perform a non-unity magnification. Most likely, it will be desired that the optics modules residing in the back side of the system occupy minimum possible volume, so that the copies of the exit pupils (16) on the spatial filter plane (151) are much closer to each other than the typical human interpupillary distances. In such cases, magnification of the imaging system would be greater than unity and the imaging system can cause optical distortions and aberrations. In this figure, the imaging between spatial filter (151) and exit pupil planes (17) is accomplished with a single imaging lens (22). In an actual design, it should be noted that this lens can be replaced with an arbitrary imaging system that may include reflective, refractive, conventional, multi-part, diffractive, freeform components, some of which may be used off-axis and/or to introduce folds. In the figure, the virtual image (105) observed by the viewer is first formed as a real or virtual image (105) on the intermediate image plane (32). This image is mapped to the final virtual image (105) by the imaging lens (22). Note that the location of the intermediate image plane (32) depends on the distance of the virtual object plane from the user.

As illustrated in FIG. 10, at least one pointing laser beam, preferably an infrared laser beam, can be part of the light module (12) and provide a substantially focused tracking spot (27) at the exit pupil plane (17). The tracking spot (27) or multiple tracking spots (27) can easily be detected by the head tracking system and provide automatic calibration for finding the user's pupils (21b) to direct the exit pupil (16) towards the user's pupils (21b). FIG. 10 illustrates a HUD system architecture that uses two PGUs (106)—one per eye—to form an initial copy of the system exit pupils. These copies are subsequently imaged to the actual exit pupils (16) by magnifier optics, which is exemplified with a single piece lens in the figure. The visual information is generated within the PGUs (106). Here it is assumed that the image source is a spatial light modulator (13) such as LCD, LCoS, DMD. etc. which is illuminated by a light source (11).

In some embodiments, the SLMs (13) may be utilized as microdisplays performing intensity modulation, in which case they are used to display (possibly distorted versions of) perspective images of virtual content presented to the user.

In other embodiments, the SLMs (13) may be utilized as phase and/or amplitude modulators, in which case they can be used to display holograms corresponding to the virtual content presented to the user.

In some embodiments, the light source (11) may not be separately present, but may rather be attached to the spatial light modulator, such as a backlit LCD module.

In some embodiments, a light source (11) may not be utilized at all, but it may rather be an intrinsic part of the image source, such as a self-emissive micro-OLED display.

In some embodiments, the PGU (106) may be realized as a scanning laser pico-projector, in which case the initial copy of the exit pupil (16) coincides with the scanning mirror of the pico-projector.

In FIG. 10, the imaging between spatial filter (151) and exit pupil planes (17) is accomplished with a single imaging lens (22). In another embodiment, imaging lens (22) can be replaced with an arbitrary imaging system that may include reflective, refractive, conventional, multi-part, diffractive, freeform components, some of which may be used off-axis and/or to introduce folds. The virtual image observed by the user is first formed as a real image on the intermediate image plane (32). This real image is mapped to the final virtual image by the imaging lens (22). Note that the location of the intermediate image plane (32) depends on the distance of the virtual image plane (204) from the user. For a 3D virtual content, the intermediate image planes (32) for each virtual image plane (204) form a continuum.

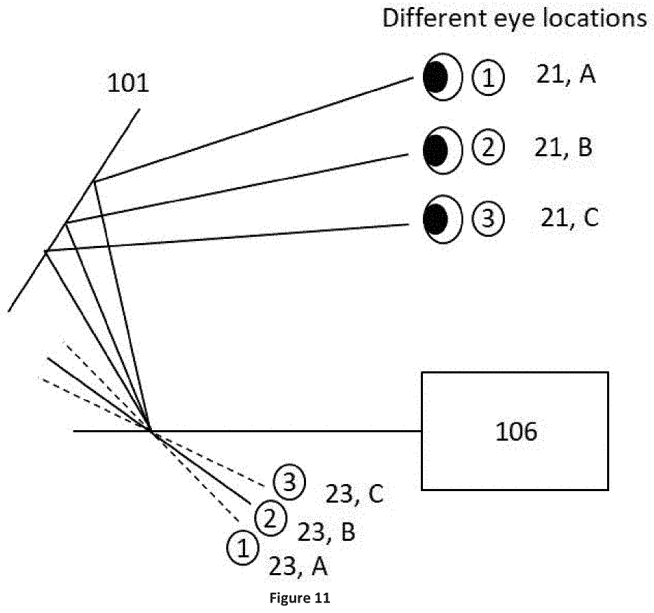

Referring to FIG. 11, PGU (106) provides illumination to the optical steering means, which is illustrated with a scanning mirror or a steering mirror (23) in the current embodiment. As the user's eye (21) moves to different locations shown as 21-A, 21-B, 21-C, head tracker camera (102) detects the new position of the user's pupil (21b) and the steering mirror (23) is deflected to positions 23-A, 23-B, and 23-C according to it.

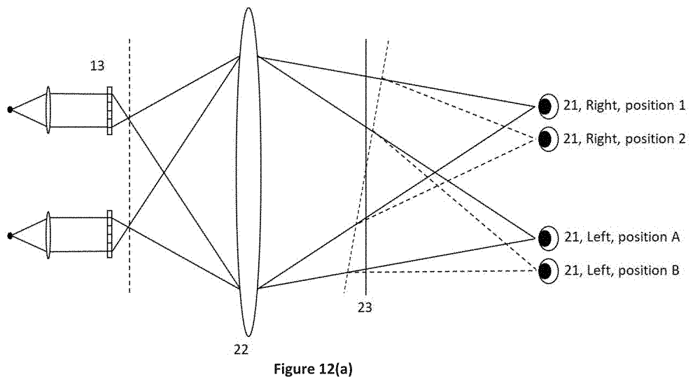

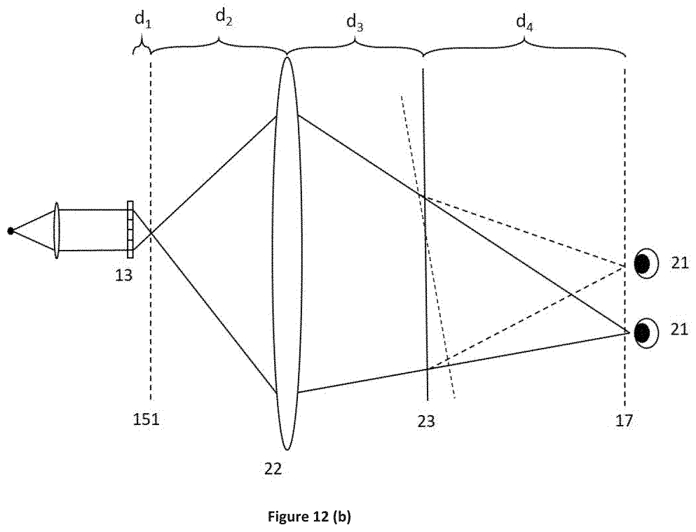

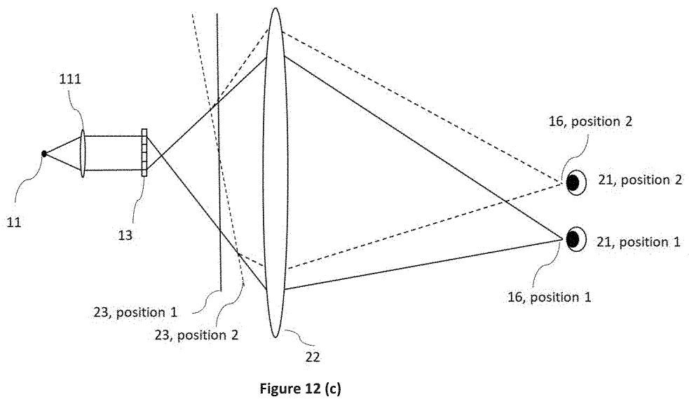

Referring to FIG. 12a, a steering mirror (23) effectively rotates the virtual space lying behind it around its axis of rotation. Rotation of the steering mirror (23) can cause rotation of the virtual objects as well. Correct perspective images need to be rendered according to the location of the users' left and right eyes (21, left) and (21, right) and their positions. In particular cases, where the steering mirror (23) is conjugate to an object plane, the virtual object placed on the virtual image (105) plane remains stationary, regardless of the rotation of the steering mirror (23). The steering mirror (23) is placed at a plane between the imaging lens (22) and exit pupil plane (17). In such cases, the required mirror clear aperture size will be large, but required tilt angles will be small. Also the imaging lens (22) will be small. Steering of the exit pupil can be accomplished via a scanning mirror. The scanning mirror can be placed at various locations in the HUD system.

In FIG. 12a, the scanning mirror is placed at a plane between the imaging lens (22) and exit pupil plane (17). In such cases, the required mirror aperture size will be large, but required tilt angles to address different exit pupil (16) positions will be small.

Note that in the configuration in FIG. 12a, the required aperture size for the imaging lens is smaller in comparison to that in FIG. 12c, for the same field of view. This provides an additional advantage in terms of aberrations caused by the imaging optics, and also is likely to keep the overall optics more compact.

Note that a scanning mirror effectively rotates the virtual space lying behind it around its axis of rotation. In general, if the content on the image source is not updated, a scanning mirror will cause rotation of the virtual objects as well. Therefore, in general, the content on the image source needs to be calculated for each new scan position, based on correct perspective images rendered according to the location of the exit pupils (16).

In particular cases, where the rotating mirror is conjugate to an object plane (such as FIG. 12c), the virtual object placed on that plane remains stationary, regardless of the movement of the scanning mirror.

In FIG. 12b, the spatial filter (151) plane is an optical conjugate of the light source (11) and the exit pupil plane (17). Given the distances illustrated in FIG. 12b and assuming the imaging lens (22) has an effective focal length of f, the following relationships are satisfied in the current embodiment.

$$\frac{1}{{d}_{2}} + \frac{1}{{d}_{3} + {d}_{4}} = \frac{1}{f} \\ \frac{1}{{d}_{1} + {d}_{2}} + \frac{1}{{d}_{3}} = \frac{1}{f}$$

In FIG. 12c, the steering mirror (23) is placed at a plane between the spatial filter (151) plane and the imaging lens (22). In such cases, the required clear aperture of the steering mirror (23) will be smaller, but required tilt angles will be larger. Note that for the same field of view, the required clear aperture size for the imaging lens (22) for FIG. 12a is smaller in comparison to that of FIG. 12c. Smaller clear aperture provides important additional advantages as it reduces the aberrations caused by the imaging lens (22) or lenses and reduces the overall volume of the HUD (10) optics.

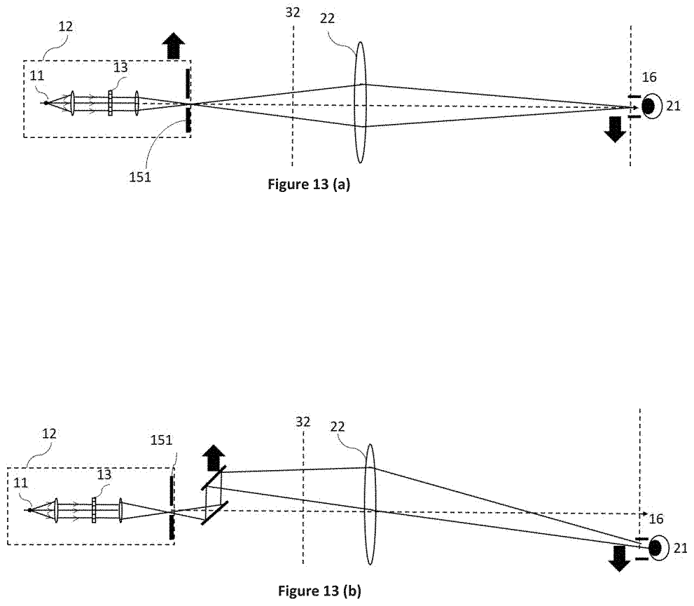

Referring to FIG. 13a, head tilt can be compensated by moving one eye light module (12) relative to the other eye light module (12). FIG. 13b demonstrate moving the exit pupil (16) vertically for one eye using two fold mirrors, where one of the mirrors is movable as illustrated. Vertical up motion of the fold mirror results in the vertical down movement of the corresponding exit pupil (16). In some embodiments, PGUs (106) themselves can be moved up/down or left/right to change the transverse position of the exit pupils (16).

In some other embodiments, components placed after the PGUs (106) may be in motion to effectively move the PGUs (106) such as those illustrated in FIG. 5(a).

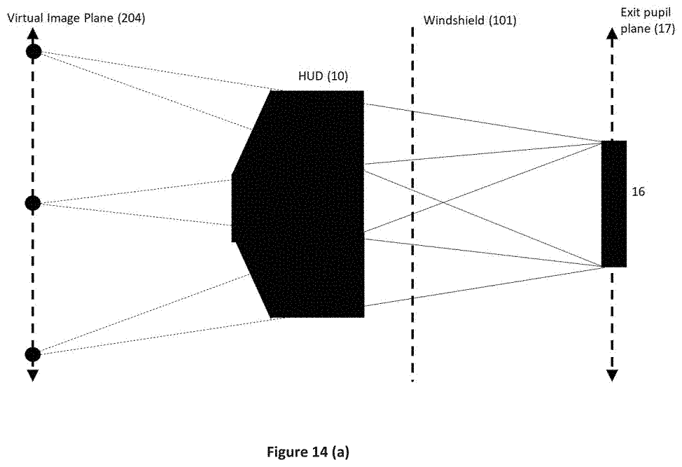

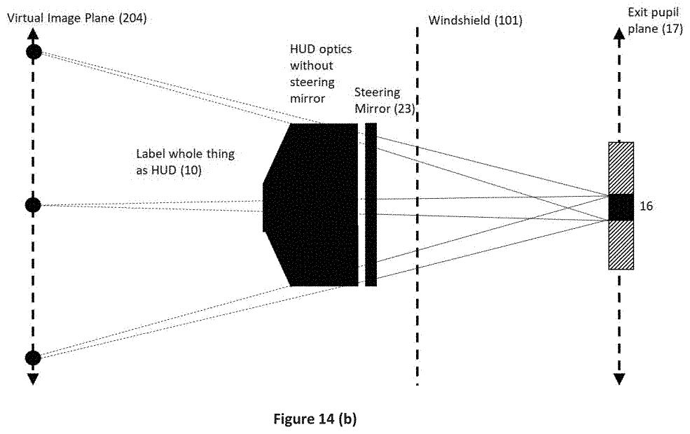

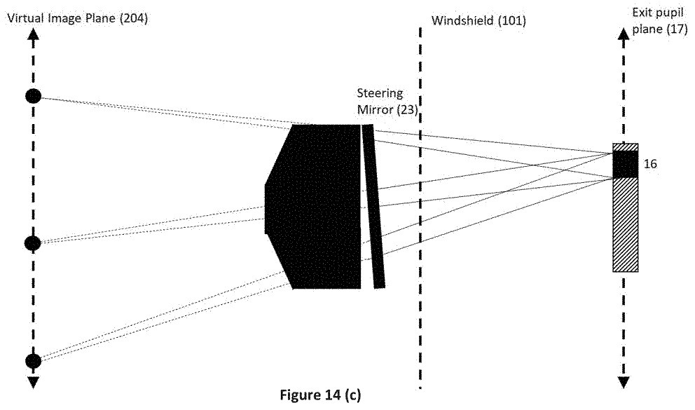

FIG. 14a shows inline equivalent of a conventional HUD system where a large eyebox is present at all times. Field-of-view is determined by the size of the virtual image plane (204) and HUD (10) size increase with the field-of-view and the exit pupil (16) size. FIG. 14b shows inline equivalent of a pupil tracker & steering mirror (23) based HUD system where a small exit pupil (16) is present at a time, and steered along with the user's eyes (21). Due to the reduction in the cone of rays delivered from virtual object points to the small eyebox, the overall size and volume of the HUD is significantly smaller in volume compared to the conventional non-tracked large eyebox designs. FIG. 14c shows exit pupil (16) steered on the exit pupil plane (17) by the steering mirror (23). The virtual image gets rotated by the rotation of the steering mirror (23). To keep virtual objects stationary at their positions, the content on the PGUs (106) should be updated with appropriate translations and rotations.

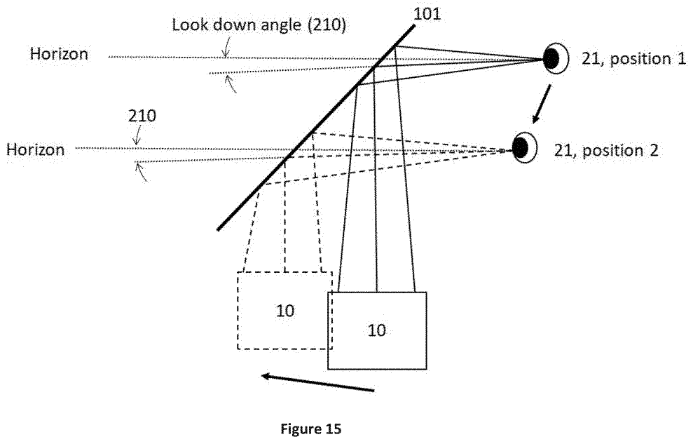

Referring to FIGS. 15, a HUD (10) system provides a constant look down angle (210) (LDA, defined as the center line of vertical FOV), regardless of the height of the driver. Zero LDA refers to the case where the center of the user's gaze is aligned with the horizon. In the case of a standard windshield (101a), this in general requires the HUD (10) module to be translated under the windshield (101) so that the vertical FOV gets centered around the LDA (210). Likewise, translation of the entire HUD (10) in the vertical direction moves the exit pupil plane (17) in the axial direction towards and away from the windshield (101). In another embodiment, the imaging lens (22), or lens system can have an adjustable focal length in order to adjust the axial position of the exit pupil (16).

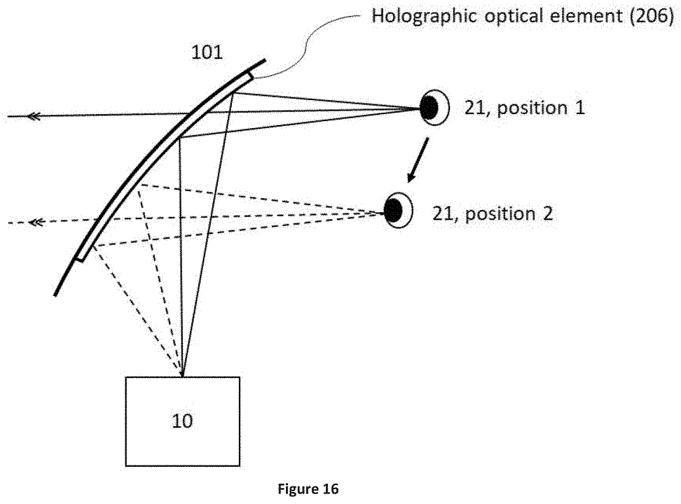

Referring to FIG. 16, in an alternative embodiment, providing a fixed LDA (210) without resorting to translational motion HUD (10) may just be rotated around its center position, which may also be avoided with steering mirror placed at the exit aperture of the HUD (10). A holographic optical element (HOE) (206) may be recorded using principles of laser interferometry and holography for three wavelengths and placed on a transparent substrate, which is then placed on the inner side of the windshield (101). The HOE (206) essentially acts like a paraboloidal mirror which images the rays emerging from the center of HUD (10) opening to infinity. In a similar manner, HUD (10) can be placed behind the steering wheel, near the ceiling of the vehicle, off-axis location near the rear-view mirror location, or behind the driver, and the HOE (206) can adjust the LDA using an additional tilt term optimized for different RGB wavelength light sources and windshield tilt angles.

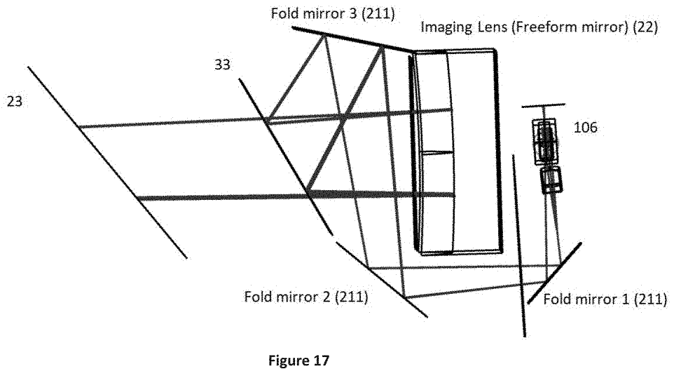

FIG. 17 shows a small volume realization of the HUD (10) optics where the light generated by the PGU (106) is directed with beam fold mirrors (211) three times, and then reflected by a beam splitter (33) or preferably by a polarized beam splitter (PBS) towards an imaging lens (22) in the form of a freeform mirror, and then redirected to the beam splitter (33) making a pass this time to arrive at the optical steering apparatus (18) in the form of a steering mirror (23). Windshield reflection ratios of s and p polarizations can be controlled by adjusting the windshield (101) angle relative to ground and by adding a polarization rotation film inside the HUD or on the windshield surface. This can enable user's wearing polarized sunglasses see the HUD display.

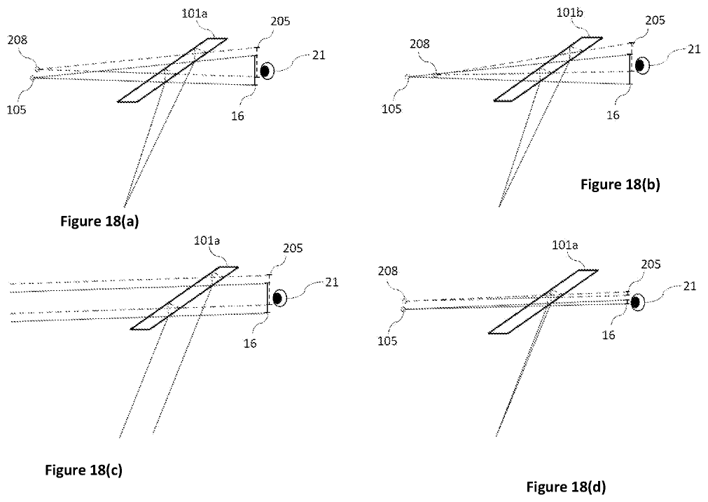

FIGS. 18a, 18b, 18c, 18d show when a standard windshield (with uniform thickness and parallel surfaces) is used and a large non-tracked exit pupil is formed, the display in general generates ghost image (208) copies of the virtual content (FIG. 18a—top left). One solution is to place the virtual display at infinity, in which case ghost image (208) and actual virtual image (105) merge into each other, eliminating the ghosting problem (FIG. 18c—bottom left). This option however requires a larger separation between the “image source (LCD)” and imaging lenses, and thus larger HUD volume. Another solution is to use a wedge windshield, in which case the ghost image (208) and actual image are merged into each other for some virtual image distance closer than infinity, depending on the wedge angle (FIG. 18b—top right). However, the ghosting problem is still resolved only for a single virtual image distance. When the driver height varies within the head volume (212), wedge windshield (101b) solution does not work well and ghost image problem persists due to changes in the optical paths and the curvature of the windshield (101). In this system, an eye-tracked small exit pupil HUD, the actual and ghost exit pupils (205) are spatially separated from each other (FIG. 18d—bottom right). As a result, ghosting problem is eliminated simultaneously for all possible virtual image distances, which is an advantage unique to small and tracked exit pupil HUD solution.

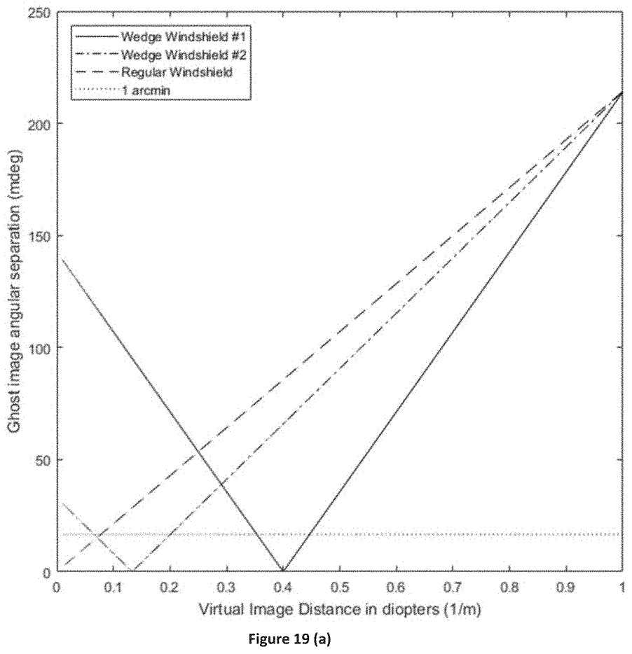

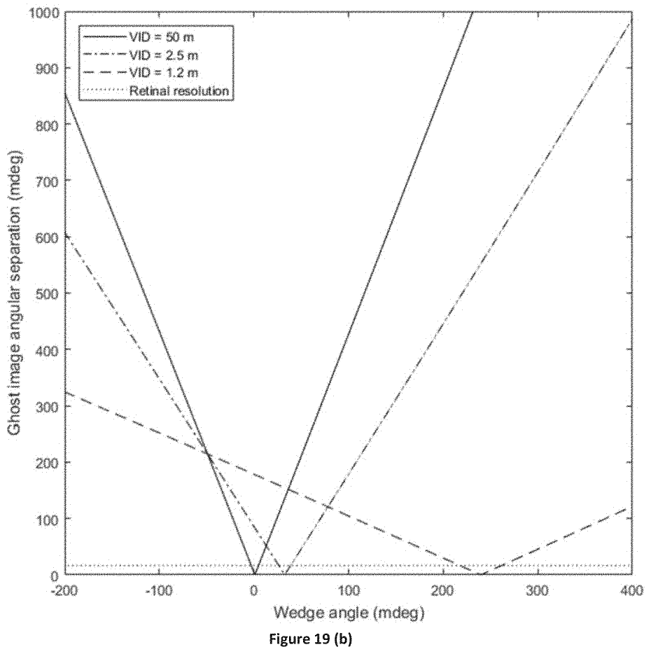

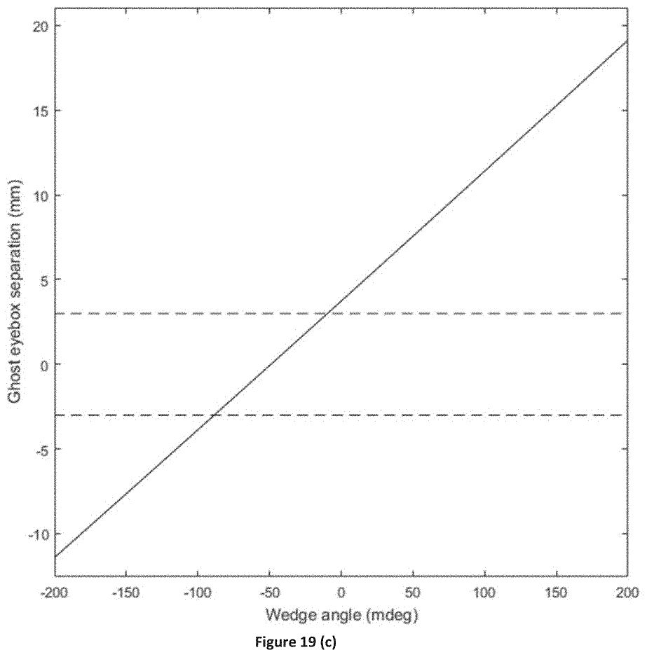

FIG. 19a shows the change in the angular separation between the virtual image (105) and the ghost image (208) is shown as a function of the virtual image plane (204) distance or virtual image (105) distance (in diopters). When the virtual image (105) distance is set to infinity, the ghost image (208) is not a problem for a standard windshield (101a). The ghost image (208) becomes apparent when the angular separation exceeds the resolution of the human eye (1 arcmin), which is the case when virtual image (105) distance is less than 12 meters. A wedge windshield (101b) with a certain constant wedge angle eliminates the ghost image (208) only for a particular virtual image (105) distance. Two different wedge windshields (101b) with wedge angles optimized for 7.5 and 2.5 meters are shown in the graph. This case is valid when the windshield (101) is flat and makes an angle of 35 degrees with the ground or horizon. The assumptions for the simulation are: refractive index of the windshield is 1.5, the windshield thickness is 5 mm at its center, and the distance between the windshield and the driver is 1 meter.

FIG. 19b shows the change in the angular separation between the virtual image (105) and the ghost image (208) is shown as a function of the wedge angle. When the virtual image distance is set to 50 meters or more, the wedge angle should be 0 to avoid ghost images. The optimal wedge angle is different for different virtual image (105) distances, as shown in the graph. The optimal wedge angle increases as the virtual image distance decreases and it is positive for all virtual image distances. This case is valid when the windshield (101) is flat and makes an angle of 35 degrees with the ground. The refractive index of the windshield is 1.5 and it has a thickness of 5 mm at its center. The distance between the windshield and the driver is assumed to be 1 meter. A positive wedge angle corresponds to the outer surface of the windshield making a steeper angle with the ground.

FIG. 19c shows the change in the distance between the center of the eyebox (exit pupil (16)) and the ghost exit pupil (205) or ghost eyebox is shown as a function of the wedge angle. A ghost eyebox separation of less than 3 mm (indicated by the dashed line) results in an overlap of the eyebox and the ghost eyebox. Nevertheless, the separation is higher than 3 mm for all positive values of the wedge angle. This case is valid when the windshield (101) is flat and makes an angle of 35 degrees with the ground. The refractive index of the windshield is 1.5 and it has a thickness of 5 mm at its center. The distance between the windshield and the driver is assumed to be 1 meter. A positive wedge angle corresponds to the outer surface of the windshield making a steeper angle with the ground. The exit pupil (16) size or eyebox size was assumed to be 3 mm.

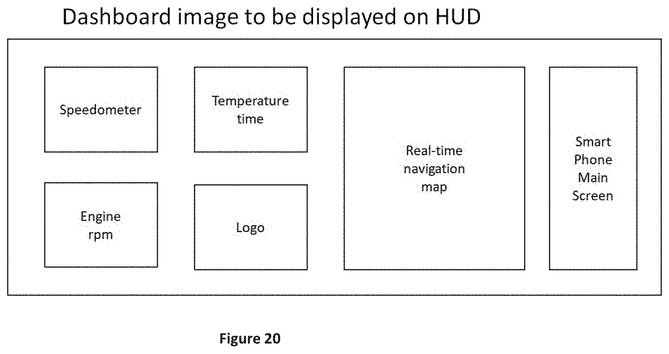

FIG. 20 illustrates a typical dashboard image to be displayed on HUD (10). Part of the dashboard data consists of speedometer, engine RPM, temperature, time readings, and logos.

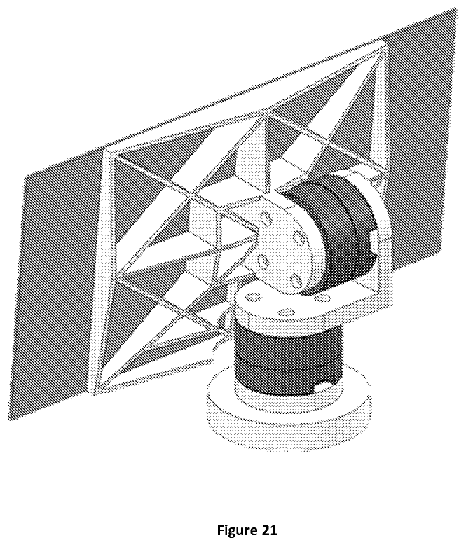

FIG. 21 shows a 2-axis rotatable steering mirror (23) structure using two electromagnetic actuated motors attached at the backside of the mirror. The configuration is designed to minimize the inertia of the steering mirror (23) structure. In an alternative embodiment, one can use a double gimbal structure. The actuator motor and its controller should be designed to provide vibration immunity. The mirror mounted on the steering mirror can be a flat steering mirror (23a) or a curved steering mirror (23b), which has optical power, or a semi-transparent optical component such as a beam-splitter. The optical steering apparatus (18) comprises said steering mirror (23), actuators to be able to move them and drivers to control them.

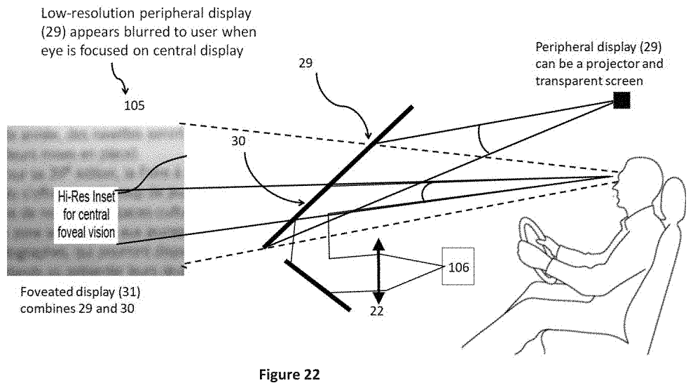

Referring to FIG. 22, a foveated display (31) combines central display (30) with small FOV and peripheral display (29) with large FOV.

Peripheral display (29) might be formed using a projector that illuminates a transparent holographic screen attached to the windshield (101). Since the peripheral display (29) image appear on the windshield (101), user's eye (21) need to focus on the windshield (101) in order to see a sharp image for the peripheral display (29) content. When the user's eye (21) is focused on the virtual image (105) provided by the central display (30) (the holographic projection module or LCoS, DMD, or scanning laser projector), the peripheral display (29) image appears blurred as illustrated in the figure.

In an embodiment, said steering mirror (23) is placed between the imaging lens (22) and windshield (101) thus making the steering mirror (23) clear aperture smaller than the imaging lens′ (22) clear aperture.

In an embodiment, spatial light modulator image appears at distance between 25 cm and 100 cm away from the exit pupil plane (17) towards a windshield (101).

In an embodiment, spatial light modulator image appears at a distance between 100 cm and 500 cm away from the exit pupil plane (17) towards a windshield (101).

In an embodiment, spatial light modulator image appears behind the exit pupil plane (17) away from a windshield (101).

In an embodiment, said spatial light modulator (13) is a phase-only device.

In an embodiment, said spatial light modulator (13) is device is a tiled array of spatial light modulators (13) that are combined optically.

In an embodiment, said spatial light modulator (13) spatially modulates the phase, the intensity or a combination of the incident light from the light source (11).

In an embodiment, said spatial light modulator (13) further comprises at least two sections containing color filters.

In an embodiment, said light source (11) is an LED, superluminescent LED, a laser diode or a laser light source coupled to an optical fiber.

In an embodiment, said light source (11) is incident on the spatial light modulator (13) using off-axis illumination or a waveguide plate.

In one aspect, a head-up display device (10) comprising at least one picture generation unit (106) wherein each of the at least one picture generation unit (106) is configured to generate a light beam carrying visual information and to create a virtual image (105).

In another aspect, each of the at least one picture generation unit (106) is configured to form an exit pupil (16) on an exit pupil plane (17) for viewing the head-up display content.

In a further aspect, the head-up display device (10) further comprises an optical steering apparatus (18) placed between the at least one picture generation unit (106) and the exit pupil plane (17) such that the exit pupil (16) created by the at least one picture generation unit (106) are steerable across the exit pupil plane (17) on the extended pupil region of the head volume (212) whereby light efficient and smaller volume head-up display device (10) is obtained.

In a further aspect, said exit pupils (16) are steered dynamically using the optical steering apparatus (18) to align with the position of the user's pupils (21b).

In a further aspect, each of the at least one picture generation unit (106) is configured to form an intermediate exit pupil plane (24).

In a further aspect, an intermediate image plane (32) is formed at an optical conjugate of the virtual image (105).

In a further aspect, the visual information from each of the at least one picture generation unit (106) is updated according to position of the user's pupil (21b).

In a further aspect, head-up display device (10) is an augmented reality head-up display where the image is seen through a windshield (101) or an optical combiner.

In a further aspect, exit pupil (16) is dimensioned to extend along one or both axis smaller than 15 mm.

In a further aspect, two separate picture generation units (106) are configured to generate two light beams carrying visual information to form two distinct exit pupils (16) for every virtual image.

In a further aspect, one picture generation unit (106) is configured to generate light beams carrying visual information to form one exit pupil (16) which covers one or two user's eye (21) for one virtual image.

In a further aspect, one picture generation unit (106) is configured to generate light beams carrying visual information for one intermediate image plane (32) and to form two intermediate exit pupils (24).

In a further aspect, intermediate image plane (32) is formed such that it is free of an optical diffuser or a numerical aperture (NA) expander.

In a further aspect, short edge of said exit pupil (16) is smaller than 1 cm such that exit pupil (16) and ghost exit pupil (205) do not substantially overlap.

In a further aspect, short edge of said exit pupil (16) is smaller than 5 mm such that exit pupil (16) and ghost exit pupil (205) do not substantially overlap.

In a further aspect, short edge of said exit pupil (16) is smaller than 3 mm such that exit pupil (16) and ghost exit pupil (205) do not substantially overlap.

In a further aspect, device comprises a head tracker camera (102) facing the user such that user's pupil (21b) positions are detected.

In a further aspect, head tracker camera (102) and said optical steering apparatus (18) operate synchronously.

In a further aspect, picture generation unit (106) comprises a projector, a scanning laser, a microdisplay, an LCOS, a DLP, an OLED or a holographic projector configured to form an intermediate image plane.

In a further aspect, picture generation unit (106) forms an intermediate exit pupil plane (24) wherein a spatial filter (151) is used to control the size of the exit pupil (16).

In a further aspect, said optical steering apparatus (18) comprises rotatable steering mirror (23).

In a further aspect, said optical steering apparatus (18) comprises an actuation means in form of EM actuated motor, gimbal motor, step motor or a 3-axis actuator.

In a further aspect, said head-up display device (10) comprising two picture generation units (106) that have common actuators for left and right eye boxes.

In a further aspect, said exit pupil (16) is formed using an imaging lens (22) which images an intermediate exit pupil plane (24) to the exit pupil (16).

In a further aspect, said imaging lens (22) comprises of at least one surface with optical power consisting of reflective lens, diffractive lens, refractive lens, freeform optical elements, holographic optical elements, or a combination thereof.

In a further aspect, said picture generation units (106) themselves can be moved vertically to change the transverse position of the exit pupils (16).

In a further aspect, said picture generation units (106) themselves can be moved horizontally to change the transverse position of the exit pupils (16).

In a further aspect, said picture generation units (106) themselves can be moved on three axes of the exit pupils (16).

In a further aspect, said head-up display device (10) is configured to perform an aberration and distortion correction algorithm.

In a further aspect, said steering mirror (23) executes steering for both left eye exit pupil (16) and right eye exit pupil (16) across the exit pupil plane (17) together.

In a further aspect, field-of-view provided by each of the two exit pupil (16) aligned with the two eyes of the user provide full binocular overlap at the imaging lens (22) or the steering mirror (23) or the virtual steering mirror location (213).

In a further aspect, said windshield (101) is covered with a holographic optical element (206) for imaging.

In a further aspect, regardless of the height of the driver, the head-up display device (10) system has a constant look down angle (210).

In a further aspect, said steering mirror (23) is placed between the light module (12) and the imaging lens (22).

In a further aspect, said exit pupil plane (17) is moved within the head volume (212) by moving the entire HUD (10).

In a further aspect, said look down angle (210) variation is reduced by moving the entire head-up display device (10).

In a further aspect, said head-up display device (10) comprises a head tracking system configured to track displacement(s) of the user's head and the center positions of the user's eye (21) pupils and a processing circuitry (20) effectuating control of said optical steering apparatus (18).

In a further aspect, said windshield (101) comprising a polarizer film applied to make polarized sunglasses see the HUD display.

In a further aspect, a pointing light source in the light module (12) forms a tracking spot (27) on user's face, wherein the coordinates of the tracking spot (27) is detected by the head-tracking system.

In a further aspect, the picture generation unit (106) is realized as a scanning laser pico-projector.

In a further aspect, in accordance with the detected user's eye (21) pupil position, the processing circuitry (20) delivers signals to an array of light sources (11) configured such that one light source (11) is selectively activated at one time.

In a further aspect, a binary liquid crystal shutter where the open window is selected using input from the head tracking system.

In a further aspect, said spatial filter (151) is placed on an intermediate image plane (32) formed between the user's eye (21) and the spatial light modulator (13).

In a further aspect, the head-up display device (10) produced to be embedded in the vehicle.

In a further aspect, aberration compensation includes aberrations in relation with structural form of a windshield (101) including a wedge windshield (101b) form.

In a further aspect, user head tilt is compensated by mechanically moving at least one of light modules (12) vertically to change the location of the corresponding exit pupil (16).

In a further aspect, head tilt is compensated by moving one eye light module (12) relative to the other eye light module (12).

In a further aspect, said light module (12) comprises at least one from each of the following components: microdisplay, spatial light modulator (13), light source (11), illumination lens (111), and at least one fold mirror (211).

In a further aspect, said picture generation unit (106) comprises a DMD or an LCOS as image source.

In a further aspect, said picture generation unit (106) comprises a holographic projector, wherein a spatial light modulator (13) is placed on a collimated beam path.

In a further aspect, said picture generation unit (106) comprises a spatial filter (151) placed on the intermediate exit pupil plane (24) whereby undesired beams (14b) are eliminated.

In a further aspect, said picture generation unit (106) comprises a transmissive LCD panel and at least two back illumination light sources.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

In some examples, each unit, subunit, and/or module of the system may include a logical component. Each logical component may be hardware or a combination of hardware and software. For example, each logical component may include an application specific integrated circuit (ASIC), a

Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that comprises instructions executable with the processor or other processors to implement one or more of the features of the logical components. When any one of the logical components includes the portion of the memory that comprises instructions executable with the processor, the logical component may or may not include the processor. In some examples, each logical components may just be the portion of the memory or other physical memory that comprises instructions executable with the processor or other processor to implement the features of the corresponding logical component without the logical component including any other hardware. Because each logical component includes at least some hardware even when the included hardware comprises software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations

1. A head-up display device comprising:
a picture generation unit, the picture generation unit configured to generate a light beam carrying visual information and to create a virtual image of head-up display content comprising the visual information,
wherein said picture generation unit is configured to create an exit pupil on an exit pupil plane for viewing the head-up display content; and
an optical steering apparatus placed between the picture generation unit and the exit pupil plane such that the exit pupil created by the picture generation unit is steerable across the exit pupil plane on an extended pupil region of a head volume such that a light efficient and smaller volume head-up display device is obtained,
wherein the optical steering apparatus is configured to dynamically steer said exit pupil to align with a position of a user's pupil within the head volume,
wherein the picture generation unit is configured to form an intermediate exit pupil plane, such that an intermediate image plane is formed at an optical conjugate of the virtual image, and
wherein the visual information from the picture generation unit is updated according to a position of the user's pupil.

2. The head-up display device as set forth in claim 1, wherein said head-up display device is an augmented reality head-up display where the virtual image is seen through a windshield or an optical combiner.

3. The head-up display device as set forth in claim 1, wherein said exit pupil is dimensioned to extend along one or both of an X and a Y axis less than 15 mm.

4. The head-up display device as set forth in claim 1, wherein the picture generation unit comprises two separate picture generation units configured to generate respective light beams carrying visual information to form two distinct exit pupils to create the virtual image.

5. The head-up display device as set forth in claim 1, wherein the picture generation unit is configured to generate multiple light beams carrying visual information to form one exit pupil for the virtual image, the one exit pupil visible to one or two eyes of a user.

6. The head-up display device as set forth in claim 1, wherein the picture generation unit is configured to generate multiple light beams carrying visual information for the intermediate image plane and to form two intermediate exit pupils.

7. A head-up display device as set forth in claim 1, wherein said exit pupil is defined by a long edge and a short edge, and a length of the short edge of said exit pupil is less than the long edge and the short edge is less than 1 cm and greater than 3 mm such that the exit pupil and a ghost exit pupil do not substantially overlap.

8. The head-up display device as set forth in claim 1, further comprising a head tracker camera configured to face a user and detect pupil positions of the user.

9. The head-up display device as set forth in claim 8, wherein said head tracker camera and said optical steering apparatus operate synchronously.

10. The head-up display device as set forth in claim 1, wherein said picture generation unit comprises a projector, a scanning laser, a microdisplay, a liquid crystal technology on silicone (LCOS), a digital light processor (DLP) projector, an organic light-emitting diode (OLED) or a holographic projector configured to form the intermediate image plane.

11. The head-up display device as set forth in claim 1, further comprising a spatial filter, wherein said picture generation unit forms the intermediate exit pupil plane and wherein the spatial filter is configured to control a size of the exit pupil.

12. The head-up display device as set forth in claim 1, wherein said optical steering apparatus comprises a rotatable steering mirror.

13. The head-up display device as set forth in claim 1, wherein said optical steering apparatus comprises an actuator, the actuator comprising an electro-magnetically (EM) actuated motor, a gimbal motor, a step motor or a 3-axis actuator.

14. The head-up display device as set forth in claim 1, wherein said exit pupil comprises a right exit pupil and a left exit pupil and said head-up display device comprises two separate respective picture generation units having common actuators for the left exit pupil and the right exit pupil generated by the respective picture generation units, the common actuators actuatable to steer the left exit pupil and the right exit pupil.

15. The head-up display device as set forth in claim 1 wherein said exit pupil is formed using an imaging lens configured to image the intermediate exit pupil plane to the exit pupil.

16. The head-up display device as set forth in claim 15, wherein said imaging lens comprises at least one surface with optical power consisting of a reflective lens, a diffractive lens, a refractive lens, freeform optical elements, holographic optical elements, or a combination thereof.

17. The head-up display device as set forth in claim 1, further comprising an actuator, wherein said picture generation unit is vertically or horizontally movable by the actuator to change a transverse position of the exit pupil.

18. The head-up display device as set forth in claim 1, further comprising an actuator, wherein said picture generation unit is movable by the actuator on three axes of the exit pupil.

19. A head-up display device as set forth in claim 1, wherein said exit pupil comprises a right eye exit pupil and a left eye exit pupil generated by the picture generation unit and the optical steering apparatus comprises a steering mirror configured to steer both the left eye exit pupil and the right eye exit pupil across the exit pupil plane together.

20. The head-up display device as set forth in claim 4 wherein a field-of-view provided by each of the two distinct exit pupils aligned with two eyes of a user to provide full binocular overlap at an imaging lens or a steering mirror or a virtual steering mirror location positioned between the picture generation unit and the two eyes of the user.

21. The head-up display device as set forth in claim 1, wherein the head-up display device maintains a constant look down angle of a user's eyes.

22. The head-up display device as set forth in claim 12, wherein said rotatable steering mirror is positioned between a light source included in the picture generation unit and an imaging lens.

23. The head-up display device as set forth in claim 1, wherein said picture generation unit is movable to move said exit pupil plane within the head volume.

24. The head-up display device as set forth in claim 1, further comprising a head tracking system configured to track displacement(s) of a user's head and center positions of a user's eye pupils and a processor circuitry configured to control said optical steering apparatus.

25. The head-up display device as set forth in claim 24, wherein the picture generation unit comprises a pointing light source, wherein the head tracking system is configured to detect coordinates of a tracking spot generated by the pointing light source on a user's face.

26. The head-up display device as set forth in claim 1, wherein the picture generation unit comprises a scanning laser pico-projector.

27. The head-up display device as set forth in claim 24, wherein in accordance with detection of a position of the user's eye pupils, the processor circuitry is configured to deliver signals to;
selectively activate an array of light sources such that one light source is selectively activated at one time.

28. The head-up display device as set forth in claim 24, further comprising a binary liquid crystal shutter positioned at the intermediate exit pupil plane where an open window is selected using input from the head tracking system.

29. The head-up display device as set forth in claim 11, wherein said spatial filter is positioned on the intermediate image plane formed between a user's eye and a spatial light modulator included in the picture generation unit.

30. The head-up display device as set forth in claim 1 wherein the picture generation unit includes a light source and user head tilt is compensated by mechanical movement of the light source vertically to change a location of the exit pupil.

32. The head-up display device as set forth in claim 1, wherein the picture generation unit includes a plurality of eye light modules and wherein head tilt is compensated by movement of one eye light module relative to an other eye light module.

33. The head-up display device as set forth in claim 32, wherein said eye light modules comprise at least one of: a microdisplay, a spatial light modulator, a light source, an illumination lens, or at least one fold mirror.

34. The head-up display device as set forth in claim 1, wherein said picture generation unit comprises a digital mirromirror device (DMD) or a liquid crystal technology on silicone (LCOS) as an image source.

35. The head-up display device as set forth in claim 1, wherein said picture generation unit comprises a holographic projector, and wherein a spatial light modulator included in the holographic project is positioned on a collimated beam path.
